(19) United States
(12) Patent Application Publication
(10) Pub. No.: US 2017/0115431 A1
(43) Pub. Date: Apr. 27, 2017

(54) OPTIC AND CATALYTIC ELEMENTS CONTAINING BOSE-EINSTEIN CONDENSATES

(71) Applicants: HSIEN-YAO KONG, SHANGHAI (CN); HOKANG TECHNOLOGY CO., LTD., HSINCHU CITY (TW)

(72) Inventors: YAO CHENG, HSINCHU COUNTY (TW); KENG S. LIANG, MENLO PARK, CA (US)

(21) Appl. No.: 15/399,467

(22) Filed: Jan. 5, 2017

Related U.S. Application Data
(63) Continuation-in-part of application No. 14/376,276, filed on Dec. 18, 2014.

(51) Int. Cl. G02B 1/00; G01V 7/00; H05H 6/00; G02F 1/01; H05G 2/00

(52) U.S. Cl. CPC G02B 1/002; G02F 1/0147; H05G 2/00; H05H 6/00; G01V 7/00

(57) ABSTRACT

An element containing Bose-Einstein condensations (BECs) is disclosed. The BECs are able to interact with photons to create optic and catalytic functions including at least one of changing propagation of the photons, changing mutual coherence among the photons, changing a penetration depth of the photons, detecting the photons, changing chemical reactions occurred on a surface of the element, and changing nuclear reactions occurred in a boundary or an implanted crystal defect containing impurity.

### CROSS REFERENCE TO RELATED APPLICATIONS

This application is a continuation-in-part (CIP) application of U.S. application Ser. No. 14/376,276, filed Dec. 18, 2014, which is a 35 U.S.C. §371 national stage application of PCT/CN2012/070863, filed Feb. 3, 2012. The above-referenced applications are hereby incorporated herein by reference in their entirety.

### BACKGROUND

Bose-Einstein condensates (BECs) can be generated by various methods including those disclosed in U.S. patent application Ser. No. 14/376,276 [reference 1] and Leggett, A. J. Quantum Liquids, Oxford University Press, Oxford, 2007 [reference 2]. Moreover, some features of BECs have been reported in Cheng, Y., Guo Z.-Y., Y.-L., Lee, C.-H., Young, B.-L. Magnetoelectric effect induced by the delocalised ^{93m}Nb state, Radiation effects and Deject in Solids 170 43-54, 2015 [reference 3], Liu, Y.-Y. and Cheng, Y. Impurity channels of the long-lived Mossbauer effect, Sci. Rep. 5, 15741; doi: 10.1038/srep15741, 2015 [reference 4], and Cheng, Y., Yang, S.-H., Lan, M., Lee, C.-H. Observations on the long-lived Mossbauer effects of ^{93m}Nb. Sci. Rep. 6, 36144; doi: 10.1038/srep36144, 2016 [reference 5]. These features include storing photons in the photonic lattice and increasing the photon intensity in crystal defects to change the nuclear branching paths of the impurity decay.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system for superradiant Rayleigh scattering, in accordance with some embodiments of the present disclosure.

FIG. 2 is a diagram showing experiment results of superradiant Rayleigh measurements.

### DETAILED DESCRIPTION

The following disclosure provides many different embodiments, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

The present disclosure applies the Bose-Einstein condensates (BECs) to provide elements for the optic and catalytic applications. Light or photon may mean all kinds of electro-magnetic waves including visible light, UV light, X rays and gamma rays. The catalytic functions include the chemical reactions regarding orbital electrons of atoms and the nuclear reactions regarding nucleus, i.e., proton and neutron. The claimed element may contain multiple BECs. Methods of generating BECs have been, for example, disclosed in the references 1 and 2. In addition, some features of BECs, which have been reported, for example, in the references 3-5, include storing photons in the photonic lattice and increasing the photon intensity in crystal defects to change the nuclear branching paths of the impurity decay. In the claimed element, photons interact with the BECs, which changes the mutual coherence among photons, changes the propagating directions of photons, increases the photoelectric transparency of the element, or detects photons. The catalytic function works like the element palladium (Pd), which changes the chemical reactions among atoms or molecules on the Pd surface. Photons stored in the photonic lattice assist the catalytic processes, which include chemical reactions and nuclear reactions.

Photons in a laser beam are coherent, which usually are generated under three conditions, i.e., cavity, amplifying material, and enough gain to create the stimulated emission [reference 6]. The present disclosure applies the interaction between photons and BECs to generate the coherent beam, rather than the conventional methods. Gamma. rays are created by the nuclear transitions [reference 7], while X rays are generated by the atomic transitions or moving charged particles. Gamma rays and X rays strongly overlap in the energy range. Most of X rays carry only one spin and gamma rays carry one or multiple spin, which depend on their associated transitions. The coherent length of gamma rays can be evaluated by their half-lives. A longer half-life gives a longer coherent length and a narrower spectral linewidth. The linewidth can be broadened by the Doppler effect of source vibration, which reduces the intrinsic coherent length. Therefore, lowering the temperature shall increase the coherent length. Photons of same energy can have a long coherent length but without their mutual coherence, i.e., not a coherent state. The present disclosure can generate the mutual coherence among photons, which are emitted from nuclear transitions, atomic transitions, or any transitions from charged particles.

BECs were discovered by the ultra-cold atoms entering ultra-low temperature of pK in 1995. BECs contain a mass center, which describe all of the microparticle motions with the macroscopic wave functions [references 2 and 8]. The present disclosure applies the interaction among BECs and photons to create the matter-wave grating, as reported in the reference [8], to control the photon propagation and their coherence. The corresponding BECs in the present disclosure are not restricted by the ultra-cold atoms. BECs may consist of the coherent nuclei to exhibit an off-diagonal long-ranged order, which are generated by their common gamma excitation [references 3-5]. These kinds of BECs have unique properties other than the ultra-cold atoms, e.g., BECs survive at the room-temperature [reference 1 and 3] and the coexistence of more than one condensate of the nuclear excitations.

The transparency of materials is important to make a lens. The present disclosure applies the interaction between photons and BECs to increase the transparency of materials, which depend on the energy, the intrinsic spin, and the coherent length of applied photons. The claimed element according to the present disclosure includes the capabilities to change photon propagation, to change the mutual coherence of photons, to increase the transparency of materials and to detect photons.

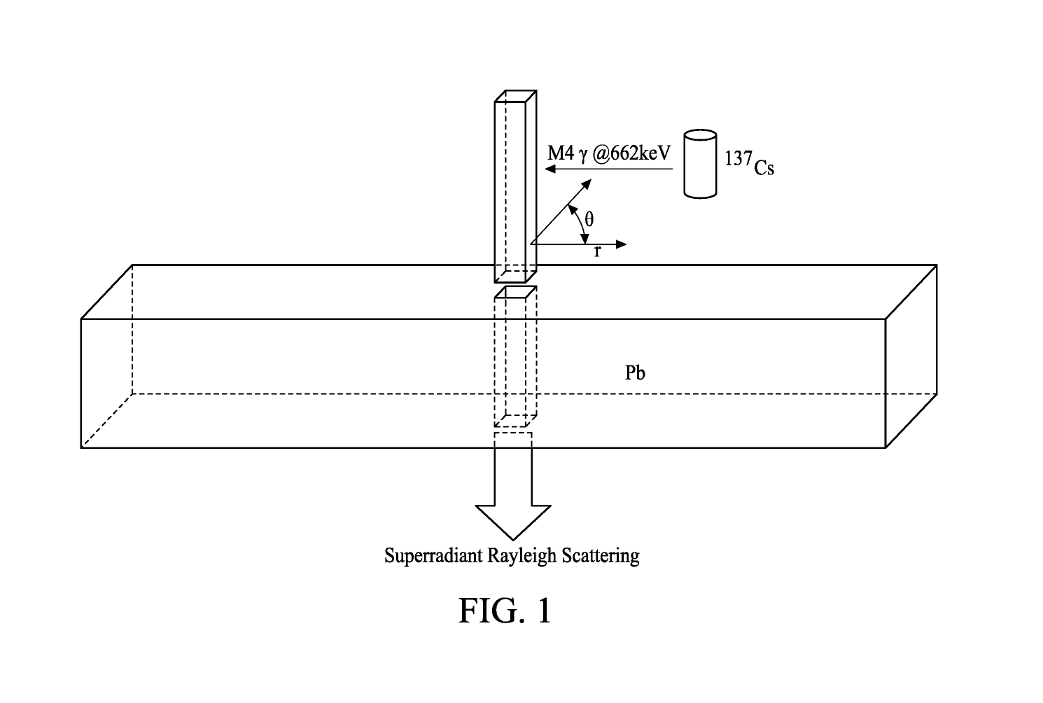

FIG. 1 shows the experimental setup of the superradiant Rayleigh, where a 2.5 mCi source of ¹³⁷Cs is placed on a Pb shielding. The shielding has Pb blocks of 8-cm thickness. A niobium (Nb) polycrystal of 99.99% purity, having a size of approximately 1 mm×1.5 cm×3 cm, is placed above the Pb block, the central hole of which collimates the M4 gamma ray of 662 keV. A preparation method to create ^{93m}Nb BEC is described in the reference [5]. The ¹³⁷Cs source is located at the position of (r=3 mm, θ=90 degrees), which emits the M4 photon of 662 keV to impinge the Nb sample from its lateral side in an impinging direction. A high-purity germanium (HPGe) detector (not shown) is located beneath the Pb shielding and detects the gamma ray emitted from the sample through the central hole. The superradiant Rayleigh gamma photons arrive at the detector via the end-fire modes of the active sample, only very few of them are directly penetrating the Pb shielding.

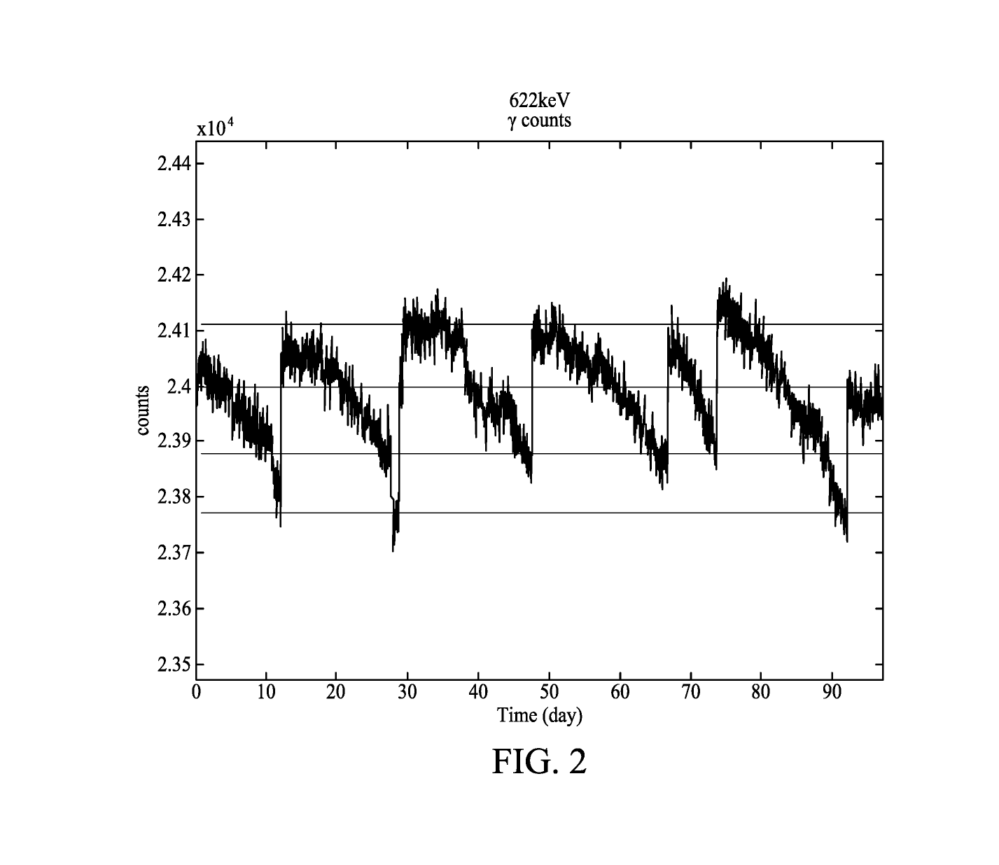

FIG. 2 shows the results of superradiant Rayleigh, where the ordinate is the counted photon numbers per minute and the abscissa is the time taking records in day. Dividing the recorded photon counts by the live time (56.4 seconds) gives the measured count rate at every data points. The ¹³⁷Cs source was placed at the position (3 mm, 90 degrees). The number of photons penetrating the Pb shielding to arrive at the detector without passing the sample was less than 10%. Every measurement took a real time of 60 seconds and storing data time of 0.25 second. The detector efficiency is about 0.5% at 662 keV measured by an isotropic emitting source, which is provided by the vendor. The data in FIG. 2 incorporate a smoothing of one hour (61 data points) to remove the shot noise. Seven oscillations appeared in the measurements taken more than three months, which proved the mutual coherence of impinging M4 photons. The superradiant Rayleigh scattering changed the propagating direction of the laterally impinging M4 photons, the efficiency of which depends on the gamma intensity. If the ¹³⁷Cs source is stronger or the impinging photons concentrate in a smaller region, the superradiant efficiency will be higher. For example, the 2.5 mCi ¹³⁷Cs source located at (1 cm, 0 degree) gave 4000 counts per second. Taken the up-down, forward-backward superradiance, 20% detector efficiency of a directional impinging and the pile-up loss of 50% dead time into account, it gave a superradiant efficiency approaching 40%, which in the meantime proved the transparency of the sample, otherwise the M4 photon of 662 keV should lose 90% intensity by passing through a 3-cm sample.

As a result, an element according to the present disclosure contains Bose-Einstein condensations (BECs) to create optic and catalytic functions including changing the propagation of photons, changing the mutual coherence among photons, changing the penetration power of photons, detecting photons, changing the chemical reactions occurred on a surface, and changing the nuclear reactions occurred in a boundary or an implanted crystal defect containing impurity.

Based on the collective nuclear coupling, the photons and the geometry of optic elements are selected to provide designed optical functions by superradiance, which are dictated by the coherent lengths of the photons regarding the geometry of optic element. The following example describes this feature, but not restricted with the materials and photons. The M4 photon of 662 keV emitted from ¹³⁷Cs source has a coherent length near 10 meters at room temperature, which can interact with the ^{93m}Nb BEC in a ⁹³Nb crystal to create the superradiance. Given three axes of the element in the length, width and height directions, if every axis of the element is greater than the coherent length of impinging M4 photons, the superradiance remains forward scattering in the same impinging direction. If the impinging direction is along the longest axis of element, the impinging M4 photon creates superradiance by forward scattering in the same direction regardless of the lengths of three axes. If the impinging direction is the short axis of element while the coherent length is longer than the short axis, the superradiance turns to a lateral direction, i.e. a long axis direction regardless of the lengths of the long axis.

BECs are applied to control the mutual coherence among photons. The following example describes this feature, but not restricted with the materials and photons. The M4 photons of 662 keV emitted from ¹³⁷Cs source can interact with the ^{93m}Nb BEC in a ⁹³Nb crystal to create a coherent superradiance.

BECs are applied to control the propagating direction of photons. The following example describes this feature, but not restricted with the materials and photons. The M4 photons of 662 keV emitted from ¹³⁷Cs source can interact with the ^{93m}Nb BEC in a ⁹³Nb crystal to create the lateral superradiance into the long axis of the BECs, i.e., the end-fire modes.

BECs are applied to control the transparency of an element containing the BECs. The following example describes this feature, but not restricted with the materials and photons. The E1 photons of 122 keV emitted from an ¹⁵²Eu source can interact with the ^{93m}Nb BEC in a ⁹³Nb crystal to create the transparency by the collective forward scattering of the 122-keV photons. The photoelectric effect to eject the Nb orbital electrons is reduced, while the mutual coherence of the impinging 122-keV photons is increased.

Changing the coherent length of photons is able to control the collective interaction between the photons and BECs and accordingly the coherent length of superradiance. For example, decreasing or increasing the temperature of a photon source is able to increase or decrease the coherent length, respectively. The change of coherent length provides the change of optical function.

In addition, changing the temperature of BECs is able to control the collective interaction between photons and BECs and accordingly the coherent length of superradiance. For example, decreasing or increasing the temperature of BECs is able to increase or decrease the coherent length of superradiance, respectively. The change of coherent length provides the corresponding precision change of a matter-wave grating.

Moreover, changing the physical length of BECs is able to control the collective interaction between photons and BEC and accordingly the coherent length of superradiance. For example, decreasing or increasing the physical length of BECs is able to decrease or increase the coherent length of superradiance, respectively. The change of coherent length provides the corresponding precision change of a matter-wave grating.

There are three ways to create interaction between photons and BECs. A photon source can be located outside or inside of BECs, or an internal source can be excited from an external impinging charged particle. The following example describes this feature, but not restricted with the materials and photons. The ^{93m}Nb BEC interacts with the M4 photon of 662 keV emitted from the ¹³⁷Cs source, which is located inside a ⁹³Nb crystal or located outside a ⁹³Nb crystal to create the superradiance. Nb atoms inside the ^{93m}Nb BEC emit Nb x rays under the irradiation of an electron beam, which is also an internal photon source.

Furthermore, changing, moving or combining the macroscopic geometry of optical elements containing BECs is able to create the designed functionalities. The functionalities of optical elements can be accomplished by a single element or a combination of elements. Apply the geometry of a cone shape, a tube shape, or line shapes to be the optical elements. In an embodiment, each of the elements may have a different geometry. A combination of the elements may provide the functionalities, e.g., focus and defocus. Moving, rotating or bending the optical elements, i.e., the mechanical motions, can control the propagating direction of superradiance.

Applying an external field to control BECs can achieve designed functionalities of an element. The following example describes this feature, but not restricted with the field and the manipulation. Applying a magnetic field to optical elements can change the interaction between photons and BECs, which can change the functionality of the optical element.

Adding a material into the element containing BECs can change the reflective index of the element, which provides the capability to modify the matter-wave grating and the features of superradiance.

A focusing superradiance can be applied as a gamma knife in medical applications or non-invasive treatment to modify some features inside an object under the medial or non-invasive treatment.

Applying the relative motion between BECs and a photon source can change the frequency of the coherent superradiance. The relative velocity causes a Doppler shift of the photon impinging on BECs, which gives rise to frequency shift of the coherent superradiance.

The interaction between BECs and superradiance is sensitive to the gravity, which can be applied to detect gravitational waves, frame dragging or the gravitational potential.

The coherent superradiance, capable of penetrating an object, can be applied to create a highly sensitive image of some particular atoms or nuclides in the object. The interaction between the coherent superradiance and nuclides or atoms depends on the nuclear and atomic species.

The interaction between BECs and an impinging photon is able to detect the impinging photon. The following example describes this feature, but riot restricted with the material, the detecting photon, and the applied field. The M4 photons of 662 keV emitted from ¹³⁷Cs source can interact with the ^{93m}Nb BEC in a ⁹³Nb crystal. The impinging of M4 662-keV photons can change the magnetoelectric effect of an element containing the BECs to give an electric signal.

A field of BECs concentrates at the crystal defect, which can catalyze a chemical reaction at a surface of an dement containing the BECs. The surface of interest can be very rough or coarse to create more surficial reaction. This catalytic reaction can be assisted by an additional implanted photon source or an externally impinging photon source.

Based on the above-mentioned feature of field concentration, the element containing BECs can be coated with a layer of assisting material or be implanted by this assisting material to create a new catalytic effect or increase the known catalytic effect. In an embodiment, the assisting material includes palladium (Pd).

Base on the above-mentioned features of field concentration and material coating, an additional field, e.g., a thermal field or an electric field, can be applied to enhance the catalytic reaction.

Based on the above-mentioned features of field concentration, material coating and application of an additional field, the described catalytic effect is not restricted by the chemical reactions, i.e., the reaction to change orbital electrons of atoms or molecules. This feature extends the catalytic effect to the nuclear reactions involving the change of nuclear states. The following example describes this feature, but not restricted with the description. Li atoms are implanted on a surface of an element containing BECs, which is inserted into water bath containing deuteron atoms. An electric field is applied to assist hydrogen atoms and the deuteron atoms to penetrate crystal defects containing the Li atom. The nuclear reaction occurs between the penetrating deuterons, the penetrating hydrogens, or the lithium impurity.

In addition, the impinging photons or implanted photon sources can be more than one kind. Furthermore, the BECs may consist of more than one nuclear excitation.

Furthermore, the multiple kinds of photons can interact with each other assisted by BECs. One kind of photon is manipulated to change another kind of photon, which may have different energy or different spin but interact with each other.

Embodiments of the present disclosure provide an element containing Bose-Einstein condensations (BECs). The BECs are able to interact with photons to create optic and catalytic functions including at least one of changing propagation of the photons, changing mutual coherence among the photons, changing a penetration depth of the photons, detecting the photons, changing chemical reactions occurred on a surface of the element, and changing nuclear reactions occurred in a boundary or an implanted crystal defect containing impurity.

Some embodiments of the present disclosure also provide a method of creating superradiance. The method includes providing an element containing Bose-Einstein condensations (BECs), and emitting photons from a source to impinge the element, the photons to interact with the BECs so as to create the superradiance.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

### REFERENCES

1. U.S. patent application, entitled “Magnetoelectric Effect Material and Method for Manufacturing Same,” filed 18 Dec. 2014 by Cheng at al. under Ser. No. 14/376,276.

2. Leggett, A. J. Quantum Liquids. (Oxford University Press, Oxford, 2007).

3. Cheng, Y., Guo Z.-Y., Liu, Y.-L., Lee, C.-H., Young, B.-L. Magnetoelectric effect induced by the delocalised 93mNb state. Radiation effects and Defect in Solids 170 43-54 (2015).

4. Liu. Y.-Y. and Cheng, Y. Impurity channels of the long-lived Mossbauer effect. Sci. Rep. 5, 15741; doi: 10.1038/srep15741 (2015).

5. Cheng, Y., Yang, S.-H., Lan, M., Lee, C.-H. Observations on the long-lived Mossbauer effects of 93mNb. Sci. Rep. 6, 36144; doi: 10.1038/srep36144 (2016).

6. Hecht, E. Optics. (Addison Wesley, San Francisco, 2002).

7. Krane, K. S. Introductory Nuclear Physics, (John Wiley & Sons, Inc., Hoboken, 1988).

8. Ritsch, H., Domokos, P., Brennecke, F. and Esslinger, T. Cold atoms in cavity-generated dynamical optical potentials. Rev. Mod. Phys. 85 553-601 (2013).

What is claimed is:

1. An element containing Bose-Einstein condensations (BECs), the BECs to interact with photons to create optic and catalytic functions including at least one of changing propagation of the photons, changing mutual coherence among the photons, changing a penetration depth of the photons, detecting the photons, changing chemical reactions occurred on a surface of the element, and changing nuclear reactions occurred in a boundary or an implanted crystal defect containing impurity.

2. A method of creating superradiance, the method comprising:
providing an element containing Bose-Einstein condensations (BECs); and
emitting photons from a source to impinge the element, the photons to interact with the BECs so as to create the superradiance.

3. The method of claim 2, further comprising:
based on collective nuclear coupling, selecting the photons and geometry of the element to provide optical functions by the superradiance.

4. The method of claim 2, wherein every axis of the element is greater than a coherent length of the impinging photons, and the superradiance remains forward scattering in the same impinging direction.

5. The method of claim 2, wherein an impinging direction is along the longest axis of the element, and the impinging photons create superradiance by forward scattering in the same direction.

6. The method of claim 2, wherein an impinging direction is the short axis of the element while a coherent length of the impinging photons is longer than the short axis, and the superradiance turns to a long axis of the element.

7. The method of claim 2, further comprising:
controlling mutual coherence among the photons by creating a coherent superradiance.

8. The method of claim 2, further comprising:
controlling a propagating direction of the photons by creating a lateral superradiance into a long axis of the BECs.

9. The method of claim 2, further comprising:
controlling transparency of the element by collective forward scattering of the photons.

10. The method of claim 2, further comprising:
controlling collective interaction between the photons and the BECs by changing a coherent length of the photons.

11. The method of claim 10, further comprising:
decreasing or increasing the temperature of the source to increase or decrease the coherent length, respectively.

12. The method of claim 2, further comprising:
controlling collective interaction between the photons and the BECs by changing the temperature of the BECs.

13. The method of claim 12, further comprising:
decreasing or increasing the temperature of the BECs to increase or decrease the coherent length of the superradiance, respectively.

14. The method of claim 2, further comprising:
controlling collective interaction between the photons and the BECs by changing a physical length of the BECs.

15. The method of claim 14, further comprising:
decreasing or increasing a physical length of the BECs to decrease or increase the coherent length of the superradiance, respectively.

16. The method of claim 2, wherein the source is located outside of the element containing the BECs.

17. The method of claim 2, wherein the source is located inside of the element containing the BECs.

18. The method of claim 2, wherein the source is located inside of the element containing the BECs but emitting photons under the irradiation of an external impinging charged particle beam.

19. The method of claim 2, further comprising:
creating optical functionalities by at least one of changing or moving the macroscopic geometry of the element or combining the macroscopic geometry of elements containing the BECs.

20. The method of claim 19, further comprising:
creating optical functionalities by at least one of changing or moving the macroscopic geometry of the element or combining the macroscopic geometry of elements containing the BECs.

21. The method of claim 20, wherein the macroscopic geometry of the element includes one of a cone shape, a tube shape and a line shape.

22. The method of claim 20, further comprising:
controlling a propagating direction of the superradiance by at least one of moving, rotating or bending the elements.

23. The method of claim 2, further comprising:
changing interaction between the photons and the BECs by applying an external field.

24. The method of claim 2, further comprising:
changing the reflective index of the element by adding a material into the element containing the BECs.

25. The method of claim 2, further comprising:
applying the superradiance as a gamma knife.

26. The method of claim 2, further comprising:
changing the frequency of a coherent superradiance by applying a relative motion between the BECs and the source.

27. The method of claim 2, further comprising:
based on the fact that interaction between the BECs and the superradiance is sensitive to the gravity, applying the element containing the BECs to detect at least one of gravitational waves, frame dragging or the gravitational potential.

28. The method of claim 2, further comprising:
based on the fact that interaction between a coherent superradiance and nuclides or atoms depends on the nuclear and atomic species, applying a coherent superradiance penetrating an object to create an image of atom or nuclide in the object.

29. The method of claim 2, further comprising:
detecting an impinging photon by an interaction between the BCEs and the impinging photon.

30. The method of claim 2, further comprising:
based on the fact that a field of BECs concentrates at a crystal defect, catalyzing a chemical reaction at a surface of the element.

31. The method of claim 30, further comprising:
providing an additional implanted photon source or an externally impinging photon source or an external impinging charged particle to assist the catalytic reaction.

32. The method of claim 31, wherein the impinging photons or impinging charged particle or implanted photon sources includes different kinds of photon sources.

33. The method of claim 32, wherein the different kinds of photon sources interact with each other.

34. The method of claim 30, further comprising:
creating a new catalytic effect or increasing the catalytic reaction by coating the element containing the BECs with a layer of assisting material or implanting the assisting material to the element containing the BECs.

35. The method of claim 30, further comprising:
enhancing the catalytic reaction by applying a thermal field or an external field.

36. The method of claim 35, further comprising:
implanting Li atoms on the surface of the element, which is inserted into a water bath containing deuteron atoms; and
applying an electric field to assist hydrogen atoms and the deuteron atoms to penetrate the crystal defect containing the Li atoms.

37. The method of claim 30, wherein the catalytic reaction includes a nuclear reaction involving the change of nuclear states.
